(19) United States
(12) Patent Application Publication
(10) Pub. No.: US 2011/0111251 A1
(43) Pub. Date: May 12, 2011

(54) PROCESS FOR PRODUCING A FOAMED METAL ARTICLE AND PROCESS FOR PRODUCING A FOAMABLE METAL PRECURSOR

(76) Inventor: Ken Evans, Brampton (CA)

(21) Appl. No.: 12/761,395

(22) Filed: Apr. 16, 2010

Related U.S. Application Data
(60) Provisional application No. 61/259,963, filed on Nov. 10, 2009.

(51) Int. Cl. C22C 21/02; B22F 3/11; B32B 5/20

(52) U.S. Cl. 428/613; 419/2; 419/66; 419/67; 420/548

(57) ABSTRACT

A process for producing a foamed metal article comprises the steps of combining together at least one metal powder, silicon powder a gas-producing blowing agent to form a mixture; including graphite along with said mixture; compacting the mixture into a foamable metal precursor; placing the foamable metal precursor in a carrier; and heating the foamable metal precursor in the carrier to at least a predetermined temperature for at least a predetermined amount of time, to thereby cause the foamable metal precursor to foam, thus producing a foamed metal article.

This application is a non-provisional application claiming priority to U.S. Provisional Patent Application Ser. No. 61/259,963 filed on Nov. 10, 2009.

### FIELD OF THE INVENTION

The present invention relates to a process for foamable metals and more particularly to mixtures of foamable metal metals produced from at least one metal powder and a gas-producing blowing agent.

### BACKGROUND OF THE INVENTION

The production of foamed metal articles is well known in the art. There are various of patents and publications concerning the production of foamed metal articles, devices and processes for producing said articles, and the metal/foaming agent mixtures used therein. There are many applications for foamed metals, including, but not limited to, stiffening of hollow structures, sound and vibration dampening, inhibition of energy flows, and creation of decorative elements.

There are known prior art processes for producing such an aluminum foamed metal article includes compacting a mixture of at least one metal powder, silicon powder and a gas-producing blowing agent into a foamable metal precursor, and forming a foamed metal article from the precursor.

It has been found that it is highly desirable to form the foamed metal article by means of extrusion, using a suitable extruder.

One such prior art patent that uses extrusion in conjunction with foamable metals is U.S. Pat. No. 5,393,485 issued Feb. 28, 1995 to Worz et al, and entitled Process For The Production Of Foamable Metal Elements. This patent discloses a process for the production of foamable elements, in which a metal powder is mixed with a foaming agent powder, the powder mixture is brought to an elevated temperature in a receiver and is extruded through a die, so that the extruded part can be subsequently foamed by decomposition of the foaming agent powder by heating of the extruded part and then cooled to yield a finished foam element. The powder mixture is continuously introduced into a channel, leading to the die, which has a moving wall component by which the powder mixture is transported in the channel by friction with precompacting and is extruded through the die. The speed of the wall component is selected so that the heating necessary for the precompacting comes from heat generated in the transport operation.

Another such prior art patent that uses extrusion in conjunction with foamable metals is U.S. Pat. No. 6,524,522 issued Feb. 25, 2003 to Vaidyanathan et al, and entitled Method For Preparation Of Metallic Foam Products And Products Made. This patent relates to the extrusion freeform fabrication of low cost, in situ, metallic foam components having oriented microstructures and improved mechanical properties such as energy absorption and specific stiffness, and more specifically relates to the freeform fabrication of metallic foams to form parts having complex geometry that demonstrate superior mechanical properties and energy absorbing capacity.

It has also been found that the process of extruding a foamable metal precursor is slower than is desirable in order keep production costs at a level where the foamable metal precursor can be used to form a foamed metal article that is competitively priced with comparable foamed metal articles.

Accordingly, there is a need in the art for an improved metal/foaming agent process for the production of foamed metal articles, that is less slow and is less expensive than prior art processes.

It is an object of the present invention to provide a process for producing a foamed metal article.

It is an object of the present invention to provide a process for producing a foamed metal article, which process is relatively inexpensive.

It is an object of the present invention to provide a process for producing a foamed metal article, which process is relatively quick.

### BRIEF DESCRIPTION OF THE DRAWING

The novel features which are believed to be characteristic of the process for producing a foamed metal article and process for producing a foamable metal precursor according to the present invention, as to its structure, organization, use and method of operation, together with further objectives and advantages thereof, will be better understood from the following drawing in which a presently preferred embodiment of the invention will now be illustrated by way of example. It is expressly understood, however, that the drawing is for the purpose of illustration and description only, and are not intended as a definition of the limits of the invention. In the accompanying drawings:

FIG. 1 is a block diagrammatic view of the process for producing a foamed metal article and process for producing a foamable metal precursor according to a preferred embodiment of the present invention.

### SUMMARY OF THE INVENTION

This invention is directed to an improved process for producing foamable and foamed metal articles, and an improvement of the industrial properties of the foamable products and of the closed-cell foamed metal articles by comparison with the prior art.

In accordance with one aspect of the present invention there is disclosed a novel process for producing a foamed metal article. The process comprises the steps of combining together at least one metal powder, silicon powder and a gas-producing blowing agent to form a mixture; including graphite along with said mixture; compacting the mixture into a foamable metal precursor; placing the foamable metal precursor in a carrier; and heating the foamable metal precursor in the carrier to at least a predetermined temperature for at least a predetermined amount of time, to thereby cause the foamable metal precursor to foam, thus producing a foamed metal article.

In accordance with another aspect of the present invention there is disclosed a novel process for producing a foamable metal precursor to be used for producing a foamed metal article. The process comprises the steps of combining together at least one metal powder, silicon powder and a gas-producing blowing agent to form a mixture; including graphite along with said mixture; and compacting the mixture into a foamable metal precursor.

In accordance with yet another aspect of the present invention there is disclosed a novel foamed metal article produced by a process comprising the steps of combining together at least one metal powder, silicon powder and a gas-producing blowing agent to form a mixture; including graphite along with said mixture; compacting the mixture into a foamable metal precursor; placing the foamable metal precursor in a mould; and heating the foamable metal precursor in the mould to at least a predetermined temperature for at least a predetermined amount of time, to thereby cause the foamable metal precursor to foam, thus producing a foamed metal article.

In accordance with yet another aspect of the present invention there is disclosed a novel foamable metal precursor produced by a process comprising the steps of combining together at least one metal powder, silicon powder and a gas-producing blowing agent to form a mixture; including graphite along with said mixture; and compacting the mixture into a foamable metal precursor.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### DETAILED DESCRIPTION OF A PREFERRED EMBODIMENT

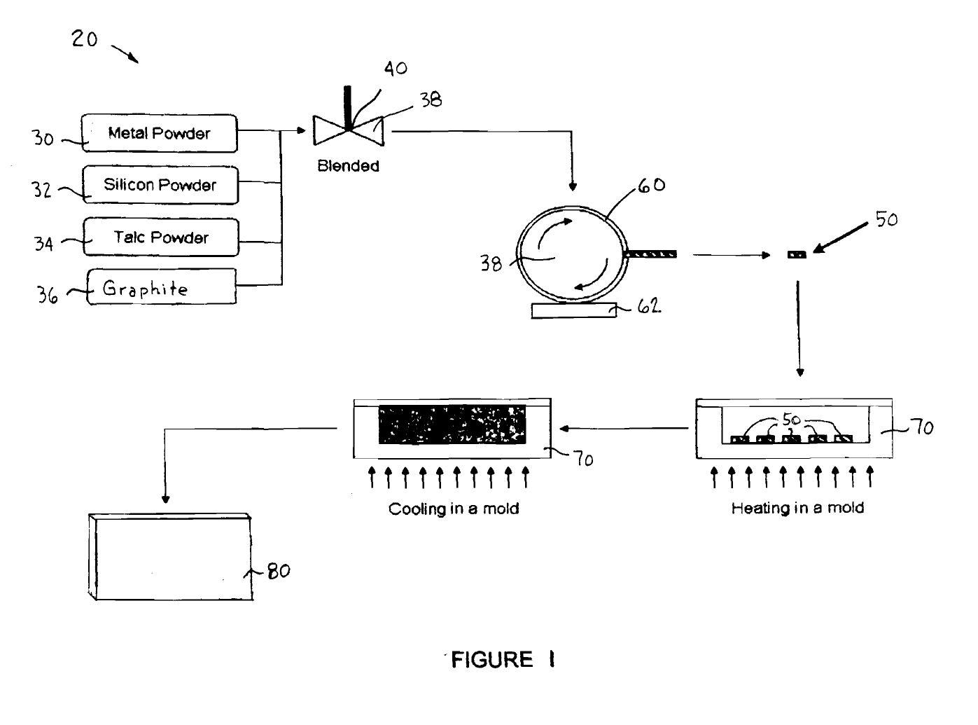

Referring to FIG. 1 of the drawings, it will be noted that FIG. 1 illustrates a preferred embodiment of the process for producing a foamed metal article and process for producing a foamable metal precursor according to the present invention, as indicated by the general reference numeral 20.

It is possible to foam all fusible metals or metal alloys in accordance with the method described herein. In one exemplary embodiment, the metal powder 30 particularly preferably employed for the purpose of the present invention is aluminum and its alloys. In this embodiment, the metal powder 30 comprises essentially aluminum, and where appropriate, conventional alloying constituents including, but not limited to, magnesium, copper, and/or silicon.

The process 20 comprises as a first step, combining together at least one metal powder 30, which in this embodiment is aluminum powder 30, silicon powder 32 and a gas-producing blowing agent 34 to form a mixture 38. The preferable manner in which the various materials are combined together is by blending in a suitable industrial blender 40. The blender 40 may be a continuous feed blender or may be an intermittent feed blender.

Any suitable gas blowing agent can be used. It has been found that hydrated magnesium silicate powder [H₂Mg₃(SiO₃)₄], [Mg₃Si₄O₁₀(OH)₂], also known by its more common name of talc powder, performs the function of a gas-producing blowing agent 34 very well.

In the preferred embodiment, as illustrated, the at least one metal powder 30 comprises aluminum powder. Alternatively, any other suitable metal powder 30 could be used, or suitable mixtures of metal powders could be used.

The next step in the process is compacting the mixture 38 into a foamable metal precursor 50 that will subsequently be used to produce a foamed metal article. This step is usually best done by also including the step of applying heat during the step of compacting the mixture 38 into a foamable metal precursor 50. The step of compacting is carried out using an extruder 60. The step of applying heat is preferably done by means of a suitable heating apparatus or element 62 within the extruder or other equipment.

The present method further comprises the step of including graphite 36 along with the mixture 38. The step of including graphite 36 along with the mixture 38 is best done by mixing the graphite 36 into the mixture 38 so that it is evenly distributed with the other components of the mixture 38. If there is graphite 36 in the mixture 38, the at least one metal powder 30 should comprise about eighty-nine percent (88%) of the mixture 38, the silicon powder 32 comprises about ten percent (10%) of the mixture 38, the gas-producing blowing agent 34 comprises about one percent (1%) of the mixture 38, and the graphite 36 comprises about one percent (1%) of the mixture 38. It has been found that the graphite 36 allows the mixture 38 to be moved through the extruder much more quickly, thus significantly cutting the overall processing, and therefore reducing manufacturing costs.

The step of compacting the mixture 38 into a foamable metal precursor is preferably carried out below the decomposition temperature of hydrated magnesium silicate powder in order to preserve the hydrated magnesium silicate powder for a subsequent step in the process. The mixture 38 is compacted to a density of at least 90 percent of the theoretical density of the metal in the metal powder, and most preferably about 98 percent of the theoretical density of the metal in the metal powder 30; however, it has been found that compacting the mixture 38 to a density of 98 percent of the theoretical density of the metal powder 30 is very difficult.

The next step is placing the foamable metal precursor 50 in a carrier 70, such as a tray, an open mould or a closed mould (as shown in the preferred embodiment. If the foamable metal precursor 50 is placed in a tray, during subsequent processing, the foamable metal precursor will form to a generally random shape. If the foamable metal precursor is placed in a closed mold, during subsequent processing, the foamable metal precursor will form to the shape of the enclosed mould. Any suitable shape of mould can be used, thus allowing many various shapes to be formed.

The final step is heating the foamable metal precursor in the carrier to at least a predetermined temperature for at least a predetermined amount of time, to thereby cause the foamable metal precursor 50 to foam, thus producing a foamed metal article 70. Typically, the foamed metal article 70 is also cooled in the same carrier for the sake of convenience, safety and product integrity.

In another aspect of the present invention, there is disclosed a process for producing a foamable metal precursor 50 to be used for producing a foamed metal article 70. The process is a subset of the above described process for process for producing a foamed metal article 70 and comprises as a first step combining together at least one metal powder 30, silicon powder 32 and a gas-producing blowing agent 34 to form a mixture 38. The second step is compacting the mixture 38 into a foamable metal precursor 50. The remaining steps and specifications related to those steps, as set forth above, apply to the process for producing a foamable metal precursor 50.

As can be understood from the above description and from the accompanying drawings, the present invention provides a process for producing a foamed metal article and process for producing a foamable metal precursor, which process is relatively inexpensive, and, which process is relatively quick, all of which features are unknown in the prior art.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Other variations of the above principles will be apparent to those who are knowledgeable in the field of the invention, and such variations are considered to be within the scope of the present invention. Further, other modifications and alterations may be used in the design and manufacture of the present invention without departing from the spirit and scope of the accompanying claims. Accordingly, it is intended that the scope of the invention be defined by the claims appended hereto.

I claim:

1. A process for producing a foamed metal article, said process comprising the steps of:
combining together at least one metal powder, silicon powder and a gas-producing blowing agent to form a mixture;
including graphite along with said mixture;
compacting said mixture into a foamable metal precursor;
placing the foamable metal precursor in a carrier; and,
heating the foamable metal precursor in said carrier to at least a predetermined temperature for at least a predetermined amount of time, to thereby cause said foamable metal precursor to foam, thus producing a foamed metal article.

2. The process of claim 1, wherein the step of including graphite along with said mixture comprises mixing said graphite into said mixture.

3. The process of claim 2, wherein the step of mixing said graphite into said mixture is done such that said graphite is substantially evenly distributed with the other components of the mixture.

4. The process of claim 1, wherein the step of compacting said mixture into a foamable metal precursor comprises extruding said mixture into a foamable metal precursor.

5. The process of claim 1, wherein said at least one metal powder comprises about eighty-nine percent (88%) of said mixture, said silicon powder comprises about ten percent (10%) of said mixture, said gas-producing blowing agent comprises about one percent (1%) of said mixture, and said graphite comprises about one percent (1%) of said mixture.

6. The process of claim 1, further comprising the step of applying heat during the step of compacting said mixture into a foamable metal precursor.

7. A process for producing a foamable metal precursor to be used for producing a foamed metal article, said process comprising the steps of:
combining together at least one metal powder, silicon powder and a gas-producing blowing agent to form a mixture;
including graphite along with said mixture; and,
compacting said mixture into a foamable metal precursor.

8. The process of claim 7, wherein the step of including graphite along with said mixture comprises mixing said graphite into said mixture.

9. The process of claim 7, wherein the step of mixing said graphite into said mixture is done such that said graphite is substantially evenly distributed with the other components of the mixture.

10. The process of claim 7, wherein the step of compacting said mixture into a foamable metal precursor comprises extruding said mixture into a foamable metal precursor.

11. The process of claim 7, wherein said at least one metal powder comprises about eighty-nine percent (88%) of said mixture, said silicon powder comprises about ten percent (10%) of said mixture, said gas-producing blowing agent comprises about one percent (1%) of said mixture, and said graphite comprises about one percent (1%) of said mixture.

12. The process of claim 7, further comprising the step of applying heat during the step of compacting said mixture into a foamable metal precursor.

13. A foamed metal article produced by a process comprising the steps of:
combining together at least one metal powder, silicon powder and a gas-producing blowing agent to form a mixture;
including graphite along with said mixture;
compacting said mixture into a foamable metal precursor;
placing the foamable metal precursor in a carrier; and,
heating the foamable metal precursor in said carrier to at least a predetermined temperature for at least a predetermined amount of time, to thereby cause said foamable metal precursor to foam, thus producing a foamed metal article.

14. A foamable metal precursor produced by a process comprising the steps of:
combining together at least one metal powder, silicon powder and a gas-producing blowing agent to form a mixture;
including graphite along with said mixture; and,
compacting said mixture into a foamable metal precursor.
